(19) United States
(12) Patent Application Publication
(10) Pub. No.: US 2006/0234631 A1
(43) Pub. Date: Oct. 19, 2006

(54) System and method for generation of interest -based wide area virtual network connections

(76) Inventor: Jorge Dieguez, Antibes (FR)

Correspondence Address: BAKER & DANIELS LLP, 805 15TH STREET, NW, SUITE 700, WASHINGTON, DC, 20005, US

(21) Appl. No.: 11/106,496

(22) Filed: Apr. 15, 2005

(51) Int. Cl. H04B 7/00

(52) U.S. Cl. 455/41.2

(57) ABSTRACT

A system and method that allows users of wireless mobile devices such as cellular telephones to automatically identify one another, alert users to detection of nearby users, transmit information of common interest and communicate in real-time at increased distances. Two mobile devices may in embodiments identify one another using Bluetooth or other short-range wireless communications, and exchange Bluetooth Identification Keys or other identification data. The identification keys may be correlated in an instant network server or other network intelligence, which may then set up a second, wide-area, real-time connection between the users. The users may then communicate in real time over the wide-era network using SMS, MMS, wireless IP, voice channel, or other networks, connections or protocols. The users may thus pass out of short-range wireless range and still maintain real-time wide-area communication with users or institutions who have registered common interests, activities or pursuits. The invention may be used in social networking, gaming, retail and other applications.

### FIELD OF THE INVENTION

The invention relates to the field of communications, and more particularly to techniques for detecting the proximity of two or more communications devices via short-range wireless channels, then establishing and managing real-time interest-based connections between those devices on a wide-area basis.

### BACKGROUND OF THE INVENTION

Innovations in mobile technology have enabled users of cellular telephones and other mobile devices to identify and communicate with other users in close range. For example, the Bluetooth communications protocol allows auto-sensing, short-range communications using radio waves. When Bluetooth-capable devices come within range of one another, the devices may identify one another and determine whether they have information to exchange. If the devices have information to communicate, a personal-area network (PAN), or piconet may be established. The devices in the piconet may communicate using relatively low-power and short-range radio waves. Once a piconet is established, the devices included in the piconet may randomly hop between radio frequencies in unison, which ensures that the devices stay in channel with one another while avoiding interference with other piconets that may be operating nearby.

One advantage of Bluetooth and other short-range wireless systems is that devices can typically establish a connection and communicate with each other with little or no input from users. For example, Bluetooth devices can identify one another, determine whether they have information to share, and communicate with one another, all without necessary user input. However, Bluetooth and other types of short-range wireless technology may be limited by the range their comparatively low-power communications signals can travel. For example, Bluetooth radio waves can typically only travel about 10 meters, limiting the range of typical Bluetooth applications.

Short-range wireless technology may however be useful in a variety of social networking or interest-based applications. For example, users of Bluetooth-enabled phones may use short-range radio communication to identify and communicate with each other. Applications for Bluetooth enabled phones, digital assistants or other devices may, for example, exchange profile information or track the locations of nearby users. However, once participating users are no longer in range, communication may be lost. Other problems in personal communications technology exist.

### SUMMARY OF THE INVENTION

The invention overcoming these and other problems in the art relates in one regard to a system and method for the generation of interest-based wide area virtual network connections, in which short-range communication protocols may be initially or temporarily used to detect the presence of two or more devices passing within proximity to each other. Those devices may exchange information to temporarily establish a piconet, as well as to transmit information regarding the coupled devices and/or their registered users to a support database. That support database may examine user profiles for the two or more detected users to determine whether they share common interests, desired activities, commercial preferences or other personal or interest-based compatibilities. According to embodiments of the invention in one regard, when compatible users are detected within a short distance of each other, the inventive platform may automatically invoke a second, wide-area or long-range communications connection between the two or more devices to permit those users to pursue common interests, activities or transactions. According to embodiments of the invention in one regard, two or more mobile telephones or other devices may for example identify one another using Bluetooth or other short-range wireless communications, and exchange Bluetooth Identification Keys (BTIDs) or other identification keys. The identification keys may be correlated in an instant network server, which may establish common interests between the users, such as for example a desire to engage in network-enabled game play, sports activities, dating or social interests, or other interests or activities. The instant network server may then initiate a real-time, wide-area connection between the users based on those common or registered interests. The wide-area connection may be or include, for example, channels set up over the cellular network using short messaging service (SMS), multimedia messaging service (MMS), wireless Internet Protocol (IP), voice channels, or other communications channels, links or protocols.

### BRIEF DESCRIPTION OF THE DRAWINGS

The invention will be described with reference to the accompanying drawings, in which like elements are referenced with like numbers, and in which:

FIG. 1 illustrates a flowchart for communication using a wide wireless virtual network, according to an embodiment of the invention;

FIG. 2 illustrates a network for communication, according to an embodiment of the invention;

FIG. 3 illustrates a flowchart for playing a game using a wide wireless virtual network, according to an embodiment of the invention;

FIG. 4 illustrates a flowchart for a retail application using a wide wireless virtual network, according to an embodiment of the invention; and

FIG. 5 illustrates a network for playing a game, according to an embodiment of the invention.

### DETAILED DESCRIPTION OF EMBODIMENTS

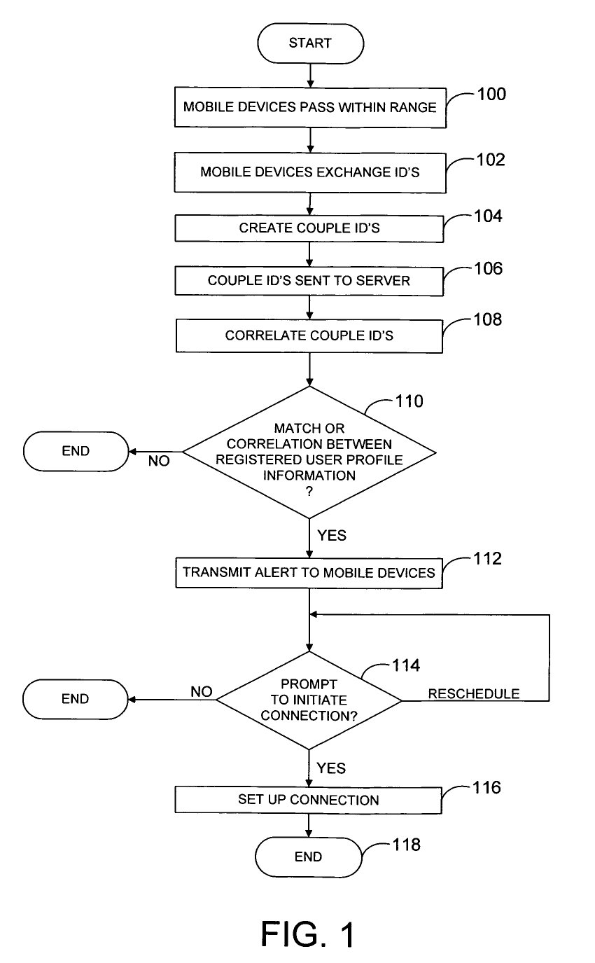

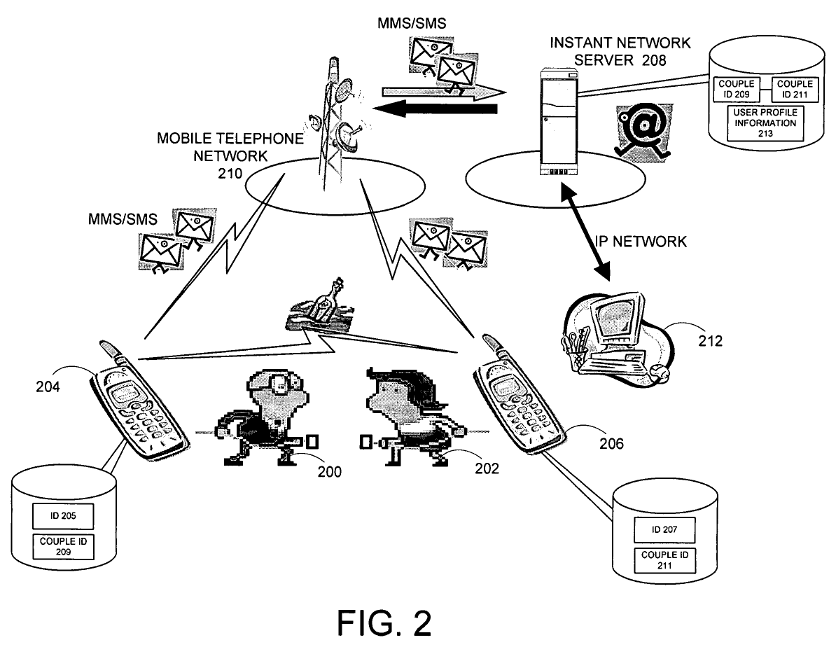

FIG. 1 illustrates a flowchart for communications processing in a self-configuring wide-area wireless virtual network, according to embodiments of the invention. In general, and as illustrated in FIG. 2 described below, that communication may take place in an environment supporting communications between two or more wireless or communication devices, such as any one or more of cellular telephones, network-enabled personal digital assistants (PDAs), personal wireless email devices, network-enabled laptop or mobile computers such as computers equipped with Wi-Fi™ connectivity, or other communications devices, clients or hardware.

Processing in that context as illustrated in FIG. 1 may begin, and in step 100 may proceed to initiate communications when two or more wireless devices, such as cellular or mobile telephones, may pass within detection range of each other. According to embodiments in one regard, passing or transiting within detection range may involve coming into relatively short-range proximity such that the phones can automatically sense or directly detect each other using Bluetooth, Whitetooth, infrared, ultra-wideband or other comparatively short-range wireless channels, connections or protocols. In the case of communication devices using Bluetooth connectivity, passing within range may therefore involve, for example, the two or more communication devices passing within approximately 10 meters or other distances of each other so that self-forming piconets or other connections may be established.

In step 102, the communication devices may exchange identification keys (IDs) using the short-range wireless channel. In one embodiment, the communication devices may exchange Bluetooth addresses (BTIDs) or other keys, codes or identifiers that identify the participating cellular/mobile telephones or other communication devices. In step 104, one or more Couple ID Keys may be created based on that exchange. According to embodiments of the invention in one regard, each communication device passing within detection range may create a Couple ID Key by appending its own identification key to the identification key or keys of the other communication device or devices in range. In step 106, the one or more Couple ID Keys may be communicated to an instant network server or other network server, intelligence or resource.

According to embodiments in one regard, each communication device may send its Couple ID Key to the instant network server using SMS, MMS, wireless IP, or other types of communications protocol, channel or connection. In step 108, the instant network server may perform a correlation of the one or more Couple ID Keys. In step 110, the instant network server or other network intelligence may determine whether the user profile information for the users whose devices have passed within range represent a potential match or correlation based on registered connection profile, interests, activities, preferences or other information reflected in that set of user profile information.

According to embodiments of the invention in one regard, the instant network server may therefore sense registered or subscribing users based on proximity in distance, proximity in time and based on potentially shared connection profile interests or other information. The user profile information may again reflect information input by or associated with the users of the communication devices reflecting interests, activities or preferences which they may wish to participate in with other users or institutions sharing those interests.

For example, the user profile information may register a user's interests in social activities, such as meeting, gathering with or dating other individuals. The user profile information may likewise register interests in sporting events or activities such as a desire to run, jog, ski, play tennis, golf, swim, play soccer or other sporting activities with others. The user profile information may for further example record or reflect gaming or game-play interests such as a desire to play in multi-player war game, action game, role-play game or other games or experiences. The user profile information may in other cases reflect a user's desire to engage in or pursue commercial or consumer activities, such as to shop or to purchase books, music, clothing, to select certain types of restaurants or hotels, or to review, be advised about or pursue other goods, products or services. Other interests, activities, pastimes and pursuits may be recorded or registered in a user's profile information or other data stores. The connection profile may predefine, for example, which network infrastructure to use and/or what kind of network connection to establish between mobile entities. For example, the connection profile may define a mobile-to-mobile connection, a mobile-to-server connection, or the like. The connection profile may predefine network infrastructure, network connections or types or priority of connections based, for example, upon service delivery requirements, the subscriber's chosen service or services, account status or other factors.

In embodiments, a given user may register or maintain multiple sets or types of interests or activities concerning which they may wish to communicate with other users or be advised of information, at the same or different times. In embodiments, for example, a user may selectively activate one or more sets of interests at one time or at one location, and another set or sets of interests at another time or another location. According to embodiments in an additional regard, one communication device may link to more than one set of user profile information for more than one user, for example to permit a family or other group to share wireless access via the communication device but selectively activate individual user profiles or registered interests. According to embodiments in one further regard, if the registered, selected or activated interests of the users of the communication devices detected within Bluetooth or other range are not matched or correlated by the instant network server or other logic, communications processing may be terminated, with or without a message to one or more of the users.

When interests or other information is partially, potentially or wholly matched, in step 112 the instant network server or other intelligence may transmit an alert to any one or more of the two or more participating communication devices to the existence and detected proximity of another subscriber or subscribers. This alert or notification may include, for example, sending a text or other greeting profile to each of the communication devices which have passed within detection range.

The greeting profile may include for example photos, personal information, interest or activity information, or other information describing the user of the far-end communication device or basis upon which the alert was generated. It may be noted that the communication devices need not remain within Bluetooth or other short-range detection proximity in order to transmit the greeting profile or other alert, since in one regard the matching of interests and other information as well as greeting/alert and other processing may according to embodiments proceed over the separate network connecting the communication devices to the instant network server, such as via the cellular telephone network including SMS, MMS, wireless IP, voice or other connections.

In step 114, the user of any participating communication device may respond to the greeting profile and any prompts or dialogues include in that greeting profile, for instance to elect to initiate a real-time connection, decline a connection, schedule a connection for a later time, make their identity, telephone number or other identifier visible or anonymous, or take other action. If one, both or all users decline to establish a connection, communications processing in embodiments may be terminated.

If one or more users respond by electing to schedule or reschedule a connection, the user may for example initiate a connection or session at a later time, for instance by sending a request to the instant network server or other network intelligence. Such a request may include, for example, the Couple ID Key for the pair of communicating devices. In embodiments in that regard, initiating or re-establishing a connection at a later time does not require that the two or more communication devices pass within range since those devices may be read out of stored data.

If both or all alerted users elect to establish a connection, in step 116 the instant network server or other network intelligence may set up a real-time connection, permitting the users to communicate in real time over the wireless operating network. Communication between the users may be transmitted and received, for example, using SMS, MMS, wireless IP, cellular voice channel, or other communications link, protocol or channel. The users who have elected to respond and participate with other detected users may thus converse or communicate using voice, text messaging, graphical, video or other information or messaging. In step 118, processing may return to a prior processing point, proceed to a further processing point, repeat or end.

According to embodiments of the invention, each communication device may store session information regarding the far-end communication device with which it has communicated, for instance in programmable electronic memory. When implemented that type of session information may include, for example, the telephone number, user name or other identifier associated with the far-end phone, the couple ID Key, the greeting profile received from the instant network server for the session, or other information. A user may browse through this session information at a later time to identify a far-end user he or she has communicated with in the past, and may in cases for example use this information to set up a subsequent real-time communication, for which later sessions additional proximity detection within range may not be necessary. According to embodiments of the invention in another regard, some or all session information regarding the far-end communication device and session data may be stored on the instant network server or elsewhere in the network. In embodiments in that regard, users may retrieve this type of session information from the server, and for example browse through the information to identify a far-end user he or she has communicated with in the past, for instance to initiate further communications or for other purposes.

Again, because the short-range wireless detection network or channel, such as Bluetooth, may only be used to discover or detect peer devices within sensing range, the communication devices are in general required to be in proximity for a short or transient time, which may be on the order of less than a second, or more or less. Once the communication devices have exchanged identifying information such as BTIDs, the users can maintain a session or connection even after they have passed out of Bluetooth range, or after they have concluded one immediate session by browsing previous session information.

FIG. 2 illustrates a network environment for interest-based communications over a wide-area virtual network, according to embodiments of the invention. As shown in that figure, users 200, 202 may communicate using mobile phones or other communication devices 204, 206. When the communication devices 204, 206 come within detection range, the communication devices may exchange identifying information such as BTIDs or other IDs 205, 207 via Bluetooth or other short-range wireless protocol. The communication devices 204, 206 may each create a Couple ID Key 209, 211 and transmit the Couple ID Key 209, 211 to an instant network server 208, for example, via a mobile telephone network 210. The instant network server 208 may retrieve and correlate the Couple ID Keys 209, 211 and transmit user profile information 213 or other data to the communication devices 204, 206, for example, again via the mobile telephone network 210. If the users 200, 202 wish to establish a real-time connection based on detected proximity and interest matching, information from the first communication device 204 may be transmitted to the instant network server 208, for example, via the mobile telephone network 210 or other network, channel, protocol or connection. The instant network server 208 may retrieve the appropriate Couple ID Key and use the Couple ID Key to identify the far-end communication device 206. The instant network server 208 may then transmit the information to the second communication device 206 via using SMS, MMS, wireless IP, Voice, or other channel, protocol or connection.

According to embodiments of the invention in one regard, a terminal 212 may be in communication with the instant network server 208 without necessarily using a mobile communications device. In embodiments, the terminal 212 may be or include, for example, a personal computer or other client or other device, for instance equipped with network connections and applications such as a Web browser or other communications tools. The terminal 212 may be used for example to edit user profile information 213 including identified interests, activities or preferences, to upload photographs, video, sound or other media, or to otherwise access or edit information.

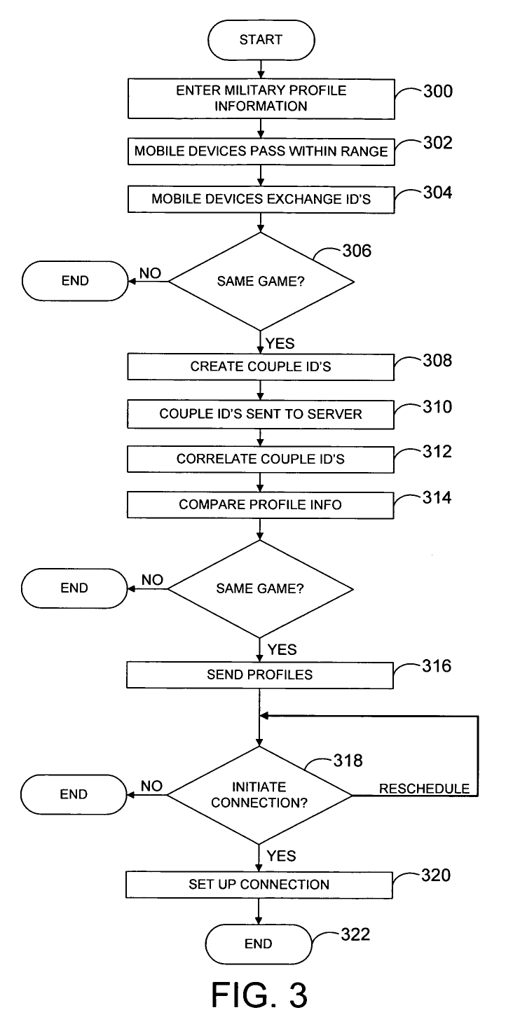

FIG. 3 illustrates a flowchart for communications processing, according to embodiments of the invention. According to embodiments illustrated in that figure, the communications processing of the invention may support interactive game-play, such as the playing of a war, action, role-play or other game or experience using a wide-area wireless virtual network. According to embodiments in this regard, communication devices such as cellular telephones may be used to mimic military radars, flight screens and other game-play scenarios. Processing may begin in step 300, wherein users may enter military profile or other game-play information before beginning the game. Depending on implementation, military profile information may includes, for example, screen name, rank, country, branch of armed services, weapons, and other scenarios or data. According to embodiments, the users may also enter a game identification (game ID) that describes the instance of the game they wish to enrol in, such as “Middle School Game No. 1.”

As described with reference to FIG. 1, in game-play embodiments two communication devices may pass within range of each other in step 302, and exchange ID information in step 304. In step 306, the communication devices may optionally determine whether they belong to the same game by exchanging and comparing game IDs. If the communication devices do not belong to or have not registered to the same game sessions, processing may be terminated.

Similar to embodiments described with reference to FIG. 1, one or more Couple ID Keys may be created in step 308, and the one or more Couple ID Keys may be communicated to an instant network server or other network intelligence in step 310. If more than one Couple ID Key is used, in step 312, the instant network server may perform a correlation of the one or more Couple ID Keys.

In step 314, the instant network server may compare game-play information such as military profile information for the two or more mobile participating communication devices. According to embodiments in one regard, the comparing of military profile information in 314 or other data may optionally include determining whether the communication devices are registered or have subscribed to the same game by comparing their game IDs or other data. If the communication devices have not registered or subscribed to the same game, processing may be terminated. Comparing military profile information 314 may also include, for example, analyzing game scenarios such as determining whether the communication devices represent enemies, allies or other roles or participants.

In step 316, the instant network server may send to each communication device the user profile information of the enemy, ally or other participant. In case of an enemy, for example, a full description of the enemy's weaponry and possible countermeasures may be sent, so that the player will be able for instance to fire missiles and counterattack, or take other measures. In case of an ally, a full description of the ally may be sent, so that for example both or all players can meet to set up common strategies and tactics, or take other action.

In the case of an ally, in step 318, the user of each communication device may elect to initiate a real-time connection, decline a connection, or schedule a connection for a later time. If one, both or all users decline a connection, processing may be terminated. If one, both or all users elect to schedule or to reschedule the connection, the user may schedule the connection at a later time by sending a request to the instant network server or other network intelligence. Such a request may include, for example, the Couple ID Key and other game or other information. Initiating or establishing the connection at a later time on this basis again may not require passing within initial detection range.

If both or all users elect to establish a wide-area connection, the instant network server may set up a real-time connection 320, and the users may communicate in real time over a wide-area network, such as the cellular telephone network. Communication between the users may be transmitted, for example, using SMS, MMS, wireless IP, voice, or other network, connection, channel or protocol. That communication may be used to track position of players in the game scenario, to keep track of scoring in the game, to record ammunition, force strength or other military or game-play variables, or otherwise support the game or role-play experience of users choosing to participate in the chosen game or activity. In step 322, processing may return to a prior processing point, proceed to a further processing point, repeat or end.

While the invention has been described in terms of a war game, many other types of games are possible. For example, the invention may be practiced in a role-playing game, gambling game, board game, sports game, or other type of suitable activity. Furthermore, information stored by the communication devices or other devices need not be limited to military profile information, but may include other game profile information, the rules of the game, the state of the game, options selectable during play of the game, or any other appropriate information. In one implementation, the communication devices or other devices may store the state of a game in progress so that users may return to the game at a later time.

Furthermore, while the invention has been described in terms of users of mobile communication devices playing a game, in embodiments, other devices, such as computer terminals, video game devices, television devices, and the like may be used to practice the present invention. For example, a user of a video game device may use the invention to play a game with users of mobile communication devices and/or users of other video game devices. Other applications of the present invention are possible.

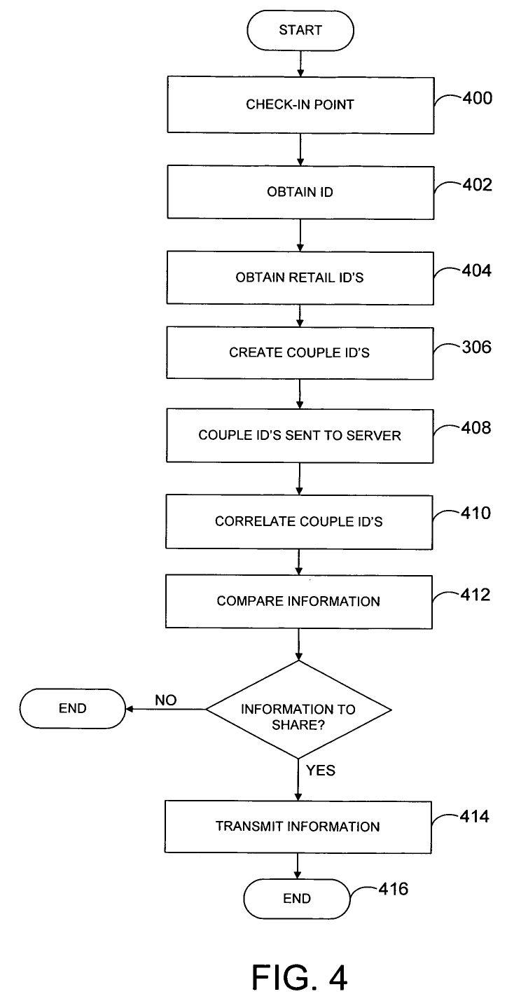

FIG. 4 illustrates a flowchart for communications processing, according to embodiments of the invention in a further regard. According to embodiments as illustrated, the participating users may be provided with a set of consumer or retail services using a wide-area wireless virtual network, triggered by short-range proximity detection. The method illustrated in FIG. 4 may be applied, for example, when a consumer or other users enter or come close to a consumer or retail area, such as a shopping mall, store, restaurant, hotel, kiosk or other commercial or other location.

Processing my begin in step 400, wherein a user may for example pass by a check-in point or other detection point or resource. The check-in point may be or include, for example, a Bluetooth access point located near the door other entrance to or location in a shopping mall, store, restaurant, hotel, kiosk or other commercial or other location. As the user passes by or in proximity to the check-in point, the ID of the user's communication device such as a cellular telephone may be obtained in step 402 for instance via a short-range wireless connection such as a Bluetooth connection. Upon detection, the ID of the user's communication device may be communicated, for example, to the instant network server or other network intelligence. In step 404, one or more Retail IDs may be obtained. Each Retail ID may be or include, for example, a BTID representing a store, restaurant, hotel, shop or other commercial or other location in the shopping mall. Each Retail ID may identify a retail computer, which may be or include, for example, a Bluetooth-enabled computer or other device located in, or otherwise related to, the corresponding shop or other location. The Retail IDs may be stored, for example, in the instant network server, or may be transmitted to the instant network server. In embodiments, the retail computer and the instant network server may be, include or be hosted in the same device or resource.

Similar to embodiments described with reference to FIG. 1, one or more Couple ID Keys may be created in step 406. According to embodiments, each Couple ID Key may be or include, for example, a concatenation of the ID of the user's mobile phone and a Retail ID. The Couple ID Keys may be created, for example, by the instant network server, by the retail computer, and/or by the user's communication device. In step 408, the one or more Couple ID Keys may be communicated to the instant network server or other network intelligence. If more than one Couple ID Key is used, in step 410, the instant network server may perform a correlation or identification of the one or more Couple ID Keys.

In step 412, information associated with the communication devices and the retail computer may be compared. The comparing of information in step 412 may include, for example, examining the user's user profile information and other data and determining whether the user has registered an interest in or preference for particular products or services available at the retail, commercial or other location. That comparison may likewise include determining whether the retail computer wishes to transmit a coupon, advertisement, promotion or other information to the communication device, or otherwise determining whether the user of the communication device and the retail computer have mutually relevant information to share. The comparing of information in step 412 may be performed, for example, by the instant network server, the retail computer or other network intelligence. If the communication device and the retail computer have information to share, the information may be transmitted in step 414, for example, using SMS, MMS, wireless IP, voice, or other communications link, channel, protocol or connection. In step 416, processing may return to a prior processing point, proceed to a further processing point, repeat or end.

According to embodiments of the invention in a further regard, generally related to a pre-ordering application, communication may be set up between a user's communication device and a retail computer when the user enters a shop or other commercial or other location. Communication in this embodiment may be maintained for different durations, for instance as long as the customer remains in the commercial or other location. When the user finds an item to purchase, according to embodiments the user may identify that item to process for a purchase or other transaction, for instance by taking a picture of the item with a mobile phone camera. The picture of the item may then be transmitted to the retail computer, as an electronic order or otherwise. According to embodiments in a further regard, the item may be identified or registered for purchase using a radio frequency identification (RFID) tag or signal.

Once an item or service is transmitted to the retail computer for purchase, the item or service may be processed or retrieved for a purchase transaction, checkout or delivery. Employees of the shop may for example retrieve the product from stock and place it at a point of sale, for pickup and removal by the user. In embodiments the shopping bag or other contents may therefore be ready for the user at the point of sale—in cases, before the user has arrived at that check-out. In other implementations, other types of information, orders and messages may be transmitted between the communication device and the retail computer, for instance to request shopping assistance, identify credit card information for payment or to leave a message for a store or other employee.

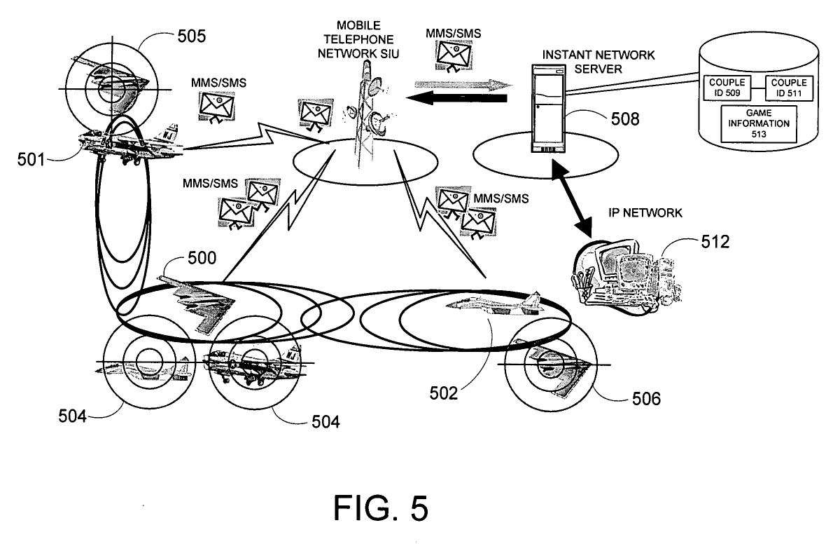

FIG. 5 illustrates a network environment for playing a game, according to embodiments of the invention. As shown in that figure, users (not shown in FIG. 5) may communicate using mobile phones or other communication devices 500, 501, 502, 503, 504, 505, 506, via a mobile telephone network 510 and an instant network server 508. In the case of a war game, each of the communication devices 500, 501, 502, 503, 504, 505, 506 may store military profile information or other game information representing, for example, a fighter jet, set of artillery, set of skills or powers, or other relevant information. Other game information for other types of games is possible. When the communication devices 500, 501, 502, 503, 504, 505, 506 come within detection range, the communication devices 500, 501, 502, 503, 504, 505, 506 may exchange Bluetooth IDs or other identifying information similarly to as discussed above with reference to FIG. 2. Each of the communication devices 500, 501, 502, 503, 504, 505, 506 may also each create a couple ID for each other detected communication device. The couple IDs may be transmitted to the instant network server 508, which correlates pairs of couple IDs 509, 511.

The instant network server 508 may send to each communication device 500, 501, 502, 503, 504, 505, 506 the military profile information or other game information 513 of the enemy, ally or other participant. A communication device 500 may receive game information 513 for each enemy 503, 504 within range. The game information 513 received for an enemy includes, for example, a full description of the enemy's weaponry and possible countermeasures may be sent, so that the user of the communication device 500 will be able, for instance, to fire missiles and counterattack, or take other measures. The communication device 500 may receive game information 513 for each ally 501, 502 within range. The game information 513 received for an ally includes, for example, a full description of the ally, so that for example both or all players can meet to set up common strategies and tactics, or take other action.

A user of the communication device 501 will receive game information 513, for example, about all allies 500 and all enemies 505 within range, and a user of the communication device 502 will receive game information 513, for example, about all allies 500 and all enemies 506 within range.

In the case of an ally, the user of each communication device 500, 501, 502, 503, 504, 505, 506 may elect to initiate a real-time connection, decline a connection, or schedule a connection for a later time. If both or all users elect to establish a wide-area connection, the instant network server 508 may set up a real-time connection, and the users may communicate in real time over a wide-area network, such as the mobile telephone network 510. Communication between the users may be transmitted, for example, using SMS, MMS, wireless IP, voice, or other network, connection, channel or protocol. That communication may be used to track position of players in the game scenario, to keep track of scoring in the game, to record ammunition, force strength or other military or game-play variables, or otherwise support the game or role-play experience of users choosing to participate in the chosen game or activity.

According to embodiments of the invention in one regard, a terminal 512 may be in communication with the instant network server 508 without necessarily using a mobile communications device. In embodiments, the terminal 512 may be or include, for example, a personal computer, video gaming device, or other client or other device, for instance equipped with network connections and applications such as a Web browser or other communications tools. The terminal 512 may be used, for example, to engage in a game with users of the communication devices 500, 501, 502, 503, 504, 505, 506 and/or to engage in a game with users of other terminals (not shown in FIG. 5).

The foregoing description of the invention is illustrative, and variations in configuration and implementation will occur to persons skilled in the art. For example, while the invention has in regards been described as employing Bluetooth connection technology to detect the presence of two or more communication devices within a short-range operating area, in embodiments other comparatively short-range detection or sensing technologies or protocols, such as infrared, Whitetooth, Wi-Fi™ (IEEE 811.a, 811.b, 811.g or other), ultra-wideband or other connections, channels or protocols may also be used.

Similarly, while the invention has generally been described as involving the matching of interests, activities, preferences and other data between users by remote lookup of user profile information at an instant network server, in embodiments the matching or correlation of interests and other data may take place in whole or part in the communication devices themselves. For example, a cellular telephone or other communication device may contain a copy of the user profile information, for example stored in electronic memory such as flash memory, on a card such as a subscriber identification module (SIM) card, or other electronic or other storage or media and transmit, and compare that information directly with user profile information from another device.

Further, while the communications processing necessary to set up a wide-area network connection between participating communication devices has generally been described as being performed by or hosted in a single instant network server, in embodiments the network intelligence for processing user interests and connection may be hosted in multiple servers, machines or resources. Other hardware, software or other resources described as singular may in embodiments be distributed, and similarly in embodiments resources described as distributed may be combined. The invention is accordingly intended to be limited only by the following claims.

What is claimed is:

1. A method for establishing communications between mobile devices, comprising:
receiving two or more wireless identification keys via a short-range wireless network, each wireless identification key identifying a corresponding mobile device;
correlating interest-based user profile data based on the two or more wireless identification keys;
transmitting a notification to at least a first mobile device based on detection of at least a second mobile device associated with the correlated interest-based user profile data; and
selectively initiating wide-area communications between at least the first mobile device and the second mobile device based on user input responsive to the notification.

2. A method according to claim 1, wherein the short-range wireless network comprises at least one of a Bluetooth network, a radio frequency ID (RFID) network and an infrared network.

3. A method according to claim 1, wherein each of the first mobile device and the second mobile device comprises at least one of a cellular telephone, a network-enabled portable computer, a network-enabled personal digital assistant and a network-enabled electronic mail device.

4. A method according to claim 1, wherein the wide-area communications comprises communicating via at least one of a cellular telephone network, a short messaging system network, a multimedia messaging service network, a wireless Internet Protocol network and a voice network.

5. A method according to claim 1, wherein the interest-based user profile data comprises at least one of social interest data, sporting activity interest data, game-play activity interest data and commercial transaction data.

6. A method according to claim 1, wherein the selective initiation of wide-area communications comprises the selective initiation of wide-area communications between at least the first mobile device, the second mobile device and a third or more mobile device.

7. A method according to claim 1, wherein the selectively initiating comprises transmitting a greeting message, the greeting message prompting the user to selectively communicate with at least one other user.

8. A method according to claim 1, wherein the correlating comprises correlating the interest-based user profile data in at least one of—
a network server, and
at least one of the first mobile device and the second mobile device.

9. A system for establishing communications between mobile devices, comprising:
an input interface for receiving two or more wireless identification keys via a short-range wireless network, each wireless identification key identifying a corresponding mobile device; and
a network server, the network server communicating with the input interface, the network server—
accessing correlated interest-based user profile data based on the two or more wireless identification keys;
transmitting a notification to at least a first mobile device based on detection of at least a second mobile device associated with the correlated interest-based user profile data; and
selectively initiating wide-area communications between at least the first mobile device and the second mobile device based on user input responsive to the notification.

10. A system according to claim 9, wherein the short-range wireless network comprises at least one of a Bluetooth network, a radio frequency ID (RFID) network and an infrared network.

11. A system according to claim 9, wherein each of the first mobile device and the second mobile device comprises at least one of a cellular telephone, a network-enabled portable computer, a network-enabled personal digital assistant and a network-enabled electronic mail device.

12. A system according to claim 9, wherein the wide-area communications comprises communicating via at least one of a cellular telephone network, a short messaging system network, a multimedia messaging service network, a wireless Internet Protocol network and a voice network.

13. A system according to claim 9, wherein the interest-based user profile data comprises at least one of social interest data, sporting activity interest data, game-play activity interest data and commercial transaction data.

14. A system according to claim 9, wherein the selective initiation of wide-area communications comprises the selective initiation of wide-area communications between at least the first mobile device, the second mobile device and a third or more mobile device.

15. A system according to claim 9, wherein the selectively initiating comprises transmitting a greeting message, the greeting message prompting the user to selectively communicate with at least one other user.

16. A system according to claim 9, wherein the correlated interest-based user profile data comprises interest-based user profile data correlated in at least one of—
the network server, and
at least one of the first mobile device and the second mobile device.

17. A communications session between mobile devices, the communications session being initiated via a method comprising:
receiving two or more wireless identification keys via a short-range wireless network, each wireless identification key identifying a corresponding mobile device;
correlating interest-based user profile data based on the two or more wireless identification keys;
transmitting a notification to at least a first mobile device based on detection of at least a second mobile device associated with the correlated interest-based user profile data; and
selectively initiating wide-area communications between at least the first mobile device and the second mobile device based on user input responsive to the notification.

18. A communications session according to claim 17, wherein the short-range wireless network comprises at least one of a Bluetooth network, a radio frequency ID (RFID) network and an infrared network.

19. A communications session according to claim 17, wherein each of the first mobile device and the second mobile device comprises at least one of a cellular telephone, a network-enabled portable computer, a network-enabled personal digital assistant and a network-enabled electronic mail device.

20. A communications session according to claim 17, wherein the wide-area communications comprises communicating via at least one of a cellular telephone network, a short messaging system network, a multimedia messaging service network, a wireless Internet Protocol network and a voice network.

21. A communications session according to claim 17, wherein the interest-based user profile data comprises at least one of social interest data, sporting activity interest data, game-play activity interest data and commercial transaction data.

22. A communications session according to claim 17, wherein the selective initiation of wide-area communications comprises the selective initiation of wide-area communications between at least the first mobile device, the second mobile device and a third or more mobile device.

23. A communications session according to claim 17, wherein the selectively initiating comprises transmitting a greeting message, the greeting message prompting the user to selectively communicate with at least one other user.

24. A communications session according to claim 17, wherein the correlating comprises correlating the interest-based user profile data in at least one of—
a network server, and
at least one of the first mobile device and the second mobile device.

25. A communications session according to claim 17, wherein selectively initiating wide-area communications between at least the first mobile device and the second mobile device is based on a connection profile describing a type of service.
